(19) United States
(12) Patent Application Publication
(10) Pub. No.: US 2008/0170289 A1
(43) Pub. Date: Jul. 17, 2008

(54) Multimode raman waveguide amplifier

(75) Inventors: Robert Rex Rice, Simi Valley, CA (US); Hagop Injeyan, Glendale, CA (US); Hiroshi Komine, Torrance, CA (US); Joseph M. Fukumoto, Rancho Palos Verdes, CA (US); Bahram Jalali, Los Angeles, CA (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Northrop Grumman Space & Mission Systems Corporation

(21) Appl. No.: 11/653,818

(22) Filed: Jan. 16, 2007

(51) Int. Cl. H01S 3/30

(52) U.S. Cl. 359/334

(57) ABSTRACT

A Raman waveguide amplifier includes a waveguide comprising a core of a Raman-active medium dimensioned and configured as a self-imaging multimode waveguide. At least one input signal is coupled into the core at a wavelength within a Raman gain spectrum of the Raman-active medium relative to at least one pump beam. The pump beam is coupled into the core so as to amplify the at least one input signal via stimulated Raman scattering to provide an output signal corresponding to an amplified replica of the at least one input signal.

### BACKGROUND

Optical amplifiers and preamplifiers perform optical amplification based on a gain medium. One type of amplifier performs optical gain by stimulated emission. For example, most amplifiers are laser amplifiers that amplify an input signal based on stimulated emission in a gain medium, such as a crystal or glass material, which is doped with laser-active ions, or an electrically pumped semiconductor. In a gain medium having weak amplification properties, the effective gain may be increased by arranging for multiple passes of the radiation through the amplifier medium.

Another type of optical amplifier operates based on optical nonlinearities of the gain medium. For example, a gain medium that exhibits parametric gain can be used to amplify an input signal using a parametric nonlinearity and one or more pump waves. Another type of nonlinear amplification relates to Raman amplification, which amplifies an input signal based on Raman gain. Raman gain corresponds to a type of optical gain arising from Raman scattering. Raman scattering relates generally to a non-instantaneous response of photons propagating through an optical medium that is caused by interaction with vibrations of the medium (phonons). Most of the Raman scattered photons are shifted to longer wavelengths, called a “Stokes shift”, and a smaller portion of the scattered photons are shifted to shorter wavelengths, called an “anti-Stokes shift”. Typical Raman-active media include certain gases and solid state media, such as glass fibers or certain crystals.

Optical amplifiers and preamplifiers are employed in a variety of technologies, including telecommunications fields, directed energy systems, object imaging systems, object positioning and tracking systems, detection systems, fiber optics, machine fabrication, and medical systems.

### SUMMARY

The present invention relates generally to a multimode Raman waveguide amplifier.

One aspect of the present invention provides a Raman waveguide amplifier that includes a waveguide comprising a core of a Raman-active medium dimensioned and configured as a self-imaging multimode waveguide. At least one input signal is coupled into the core at a wavelength within a Raman gain spectrum of the Raman-active medium relative to at least one pump beam. The pump beam is coupled into the core so as to amplify the at least one input signal via stimulated Raman scattering to provide an output signal corresponding to an amplified replica of the at least one input signal.

Another aspect of the present invention provides a Raman multimode amplifier system that includes means for propagating multiple optical modes along a direction of propagation and for periodically replicating an optical electrical field distribution at a given plane transverse to a longitudinal axis thereof in the direction of propagation at points that are multiples of a self-imaging period. The system also includes means for pumping at least one pump beam to provide for stimulated Raman scattering in the means for propagating, such that at least one Stokes signal coupled to a first end of the means for propagating is amplified by the stimulated Raman scattering to provide a corresponding output signal at a second end thereof that is an amplified replica of the at least one Stokes signal.

Yet another aspect of the present invention provides a method for amplifying a diffraction limited input optical signal. The method includes providing a waveguide core of a Raman active medium. The core is dimensioned and configured to propagate multiple optical modes along a direction of propagation and for periodically replicating an optical electrical field distribution at a given plane transverse to the direction of propagation at points that are multiples of a self-imaging period. The waveguide core is pumped with at least one pump beam within a Raman gain linewidth for the Raman active medium as to amplify the input signal through stimulated Raman scattering and thereby provide an amplified diffraction limited output signal at an output of the waveguide core.

### BRIEF DESCRIPTION OF THE DRAWINGS

FIG. 1 depicts an example of a multimode waveguide amplifier that can be implemented in accordance with an aspect of the present invention.

FIG. 2 depicts an example of another multimode waveguide amplifier that can be implemented in accordance with an aspect of the present invention.

FIG. 3 is an isometric view of part of a waveguide in accordance with an aspect of the present invention.

FIG. 4A depicts an example of a pump signal propagating through a waveguide implemented in accordance with an aspect of the present invention.

FIG. 4B depicts an example of an input signal propagating through the waveguide of FIG. 4A implemented in accordance with an aspect of the present invention.

FIG. 4C is a graph depicting self-imaging property of the input signal along the length of the waveguide in FIG. 4B in accordance with an aspect of the present invention.

FIG. 5 is a graph depicting power of a pump signal as a function of distance along a waveguide in accordance with an aspect of the present invention.

FIG. 6 is a graph depicting power of an input signal as a function of distance along a waveguide in accordance with an aspect of the present invention.

FIG. 7 depicts an example of a multimode waveguide amplifier system amplifying an input image in accordance with an aspect of the present invention.

FIG. 8 depicts an example of a ladar system implementing a multimode Raman waveguide amplifier in accordance with an aspect of the present invention.

### DETAILED DESCRIPTION

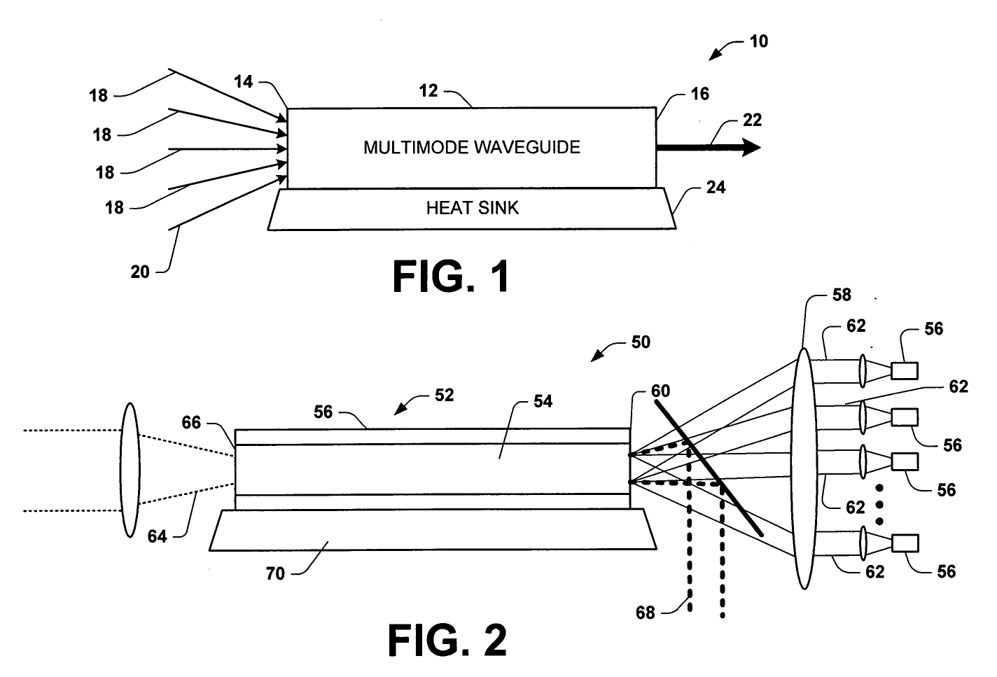

FIG. 1 depicts a schematic view of a multimode Raman waveguide system 10 that can be implemented in accordance with an aspect of the present invention. The system 10 includes a Raman active medium 12 configured as a multimode waveguide faces (or ends) 14 and 16 that are spaced apart from each other by an elongated body portion arranged in a propagation direction. The input ends 14 and 16 of the waveguide 12 can be planar and lie in a plane that is normal to a longitudinal axis of the waveguide core. Alternatively, one or both ends 14 and 16 could be non-planar or be planar but not normal to the longitudinal axis of the core. In the example of FIG. 1, the face 14 corresponds to an input face and the face 16 corresponds to an output face. The Raman active medium 12 defines the core of the waveguide. The core of the waveguide (i.e., the Raman active medium 12) is transparent at the wavelength of the pump beam(s) 18 and at a downshifted Stokes wavelength corresponding to the input beam 20. Additionally, the Raman active core can be surrounded by one or more layers of lower cladding refractive index material (not shown) to confine the optical field in the plural transverse waveguide modes of the core material.

At least one and suitably a plurality of pumping beams 18 are provided at the input end 14. An input beam 20 is also provided at the input end 14 which, in the example of FIG. 1, co-propagates through the core with the pump beams 18. The input beam is provided at a down-shifted Stokes wavelength according to the gain medium of the waveguide core. The multimode waveguide 12 provides a corresponding output beam 22 as a high-intensity, diffraction-limited beam at the Stokes wavelength corresponding to the input beam. The waveguide 12 performs the amplification of the input beam through Raman scattering process that can include both spontaneous Raman emission and stimulated Raman scattering (SRS). SRS is a process by which the presence of pump and scattered, or seed, photons leads to further stimulated scattering and coherent optical gain according to the Raman gain spectrum of the Raman active medium that forms the core.

The pump beams 18 and the input signal 20 can be co-propagating or counter-propagating or a combination of co-propagating and counter-propagating beams to provide the Raman gain at the stoke shifted wavelength. Thus, the wavelength of the pump beam 18 should be selected according to the desired wavelength of the amplified Stokes output beam 22. The pump beams 18 are provided at a wavelength that is shorter (e.g., typically a few tens of nanometers shorter) than the desired wavelength of the input Stokes beam 20, such as can be determined by adding the Raman energy according to the Stokes shifted wavelength. Stated differently, so long as the wavelength spread of the pump beams 18 are substantially within the Raman gain linewidth of the Raman active medium of the waveguide core 12, each such pump can amplify the same Stokes input beam 20 that is injected to the waveguide 12. Thus, the pump beam(s) 18 can be considered more energetic than the input signal 20. The wavelength of the respective pump beams 18 can be the same or different, so long as the pump beams are within the Raman gain linewidth of the particular Stokes signal 20 that is to be amplified. The Raman gain linewidths of various materials, such as those described herein, are well-known in the art or can be ascertained through empirical testing. Advantageously, the pump beams can be incoherent beams, such as can be provided by a plurality of lower power and beam quality readily available and relatively inexpensive optical sources. The resulting amplified output Stokes beam 22 is provided at 16 as an amplified replica of the input beam 20, which amplification occurs due to the Raman gain of the Raman active media 12. Accordingly, the input beam 20 should be provided from an appropriate source having desirable beam characteristics for the output beam 22.

No phase matching of the pump signals 18 and input signals 20 is required due to the Raman amplification process that occurs in the waveguide. That is, the Raman amplification is a multimode amplification that enables each pump mode to amplify each of the Stokes mode without regard to phase. The pump beams 18 can each be generated by a different source or the pump beams 18 can correspond to a spectrum of wavelengths such as can correspond to a broadband and multimode input beam. Those skilled in the art will understand and appreciate various types of sources from which the input beams can be generated. For example, the pump beams 18 can be provided by non-phased locked lasers, such as a quantum cascade, incoherent beams (from one or more free running lasers), color center lasers, semiconductor diode lasers) to name a few. Advantageously, the quality of the optical sources that provide the pump beams 18 can be relatively low quality (inexpensive) lasers. The wavelength of the pump beams 18, however, will determine where the Raman gain spectrum resides in wavelength for the resulting output beam 22.

The Raman active medium 12 is configured to perform Raman amplification while also exploiting self-imaging property of the waveguide core. For instance, due to self-imaging properties of the waveguide 12, the optical electrical field distribution at a given plane transverse to the axis of the waveguide is replicated periodically in the direction of propagation at points that are multiples of the image repeat distance. The distance for such periodic re-imaging, sometimes called the waveguide self-imaging period or length, which is functionally related to the index of refraction (n) of the waveguide propagation medium, the width or thickness (a) of the waveguide propagation medium, and the wavelength (λ) of the light being propagated. For example, the self-imaging period (L) can be provided as the so-called Talbot self-imaging that occurs due to constructive interference between the various waveguide modes (see, e.g., Eq. 7 herein below). Thus, the waveguide 12 periodically reconstructs or re-images the input beam spatial profile that is focused by the lens system onto the aperture or face 14 at positive integer multiples of the waveguide self-imaging period L. Accordingly, the length of the waveguide 12 can be dimensioned so that beam reconstitutes at the end 16 at which the output beam 22 is provided.

It is to be understood and appreciated that various Raman active media, such as those described herein, generate heat by the amplification process. The waveguide 12 thus can also be bonded or otherwise connected to a heat sink 24 to dissipate heat generated during operation. Accordingly, the heat from the waveguide 12 will be conducted into the heat sink 24 such that the system 10 can enable high power generation in the mid infrared region (MWIR). As mentioned above, it is desirable that the Raman active medium 12 have a high thermal conductivity to facilitate transfer of heat from the waveguide to the heat sink 24. The output Stokes signal 22 can be amplified by the SRS process according to the Raman gain spectrum of the Raman active medium 12 utilized to provide the core of the waveguide 10.

Since the waveguide is a multimode waveguide, each pump mode in the multimode Raman amplifier can couple to amplify each Stokes mode without regard to phase. This is in contrast to the non-linear gain produced by many non-linear processes, such as optical parametric amplification. Optical parametric amplification and other non-linear processes often require phase matching of input beams to provide suitable amplification. Thus, by providing multimode self-imaging waveguide that exhibits Raman amplification (e.g., due to the SRS process), a corresponding diffraction limited amplified Stokes output beam 22 can be provided at 16. Additionally, such an approach enables amplification to higher power than many existing types of amplifiers can provide at comparable beam quality.

Those skilled in the art will understand various Raman active materials and compositions that can be utilized as a multimode self-imaging waveguide according to an aspect of the present invention. Properties of desirable of Raman active medium can include: (1) transparency at the pumping wavelength and at the down-shifted Stokes wavelength; (2) large Raman gain (e.g., greater than about 3 cm/GW); (3) high thermal conductivity; (4) low non-linear absorption losses at the pump wavelength and Stokes wavelength; (5) high optical damage threshold (MW/CM²). Examples of suitable materials and their respective properties are provided in Table 1 below. As shown in Table 1, examples of Raman active medium include silicon (Si), barium nitrate (Ba(NO₃)₂), lithium iodate (LiIO₃), potassium gadolinium tungstate (KGd(WO₄)₂), calcium tungstate (CaWO₄). Other crystal materials that can be employed as the Raman active medium 12 in a self-imaging Raman waveguide include BaWO₄, SrWO₄, PbWO₄, BaMoO₄, SrMoO₄ PbMoO₄, YVO₄, and GdVO₄ crystals. Another material with excellent thermal, thermooptic and Raman gain characteristics is silicon carbide (SiC), such as the 6H and 4H polytypes. Diamond is also an excellent choice as a Raman gain medium 12 that can be utilized in a multimode Raman waveguide amplifier according to an aspect of the present invention.

From Table 1, it will be appreciated that silicon can be utilized as a Raman active medium to provide a self-imaging multimode Raman waveguide according to an aspect of the present invention. For instance, a silicon waveguide can employed to provide a high power mid wavelength infrared (MWIR) source (e.g., providing a diffraction limited output having a wavelength in a range from about 2 μm to about 5 μm). Further analysis of a multimode self-imaging Raman waveguide is provided herein below.

TABLE 1

| Property | Silicon | Ba(NO₃)₂ | LilO₃ | KGd(WO₄)₂ | CaWO₄ |
|---|---|---|---|---|---|
| Optical damage | ~1000-4000 | ~400 | ~100 | — | — |
| threshold | | | | | |
| (MW/cm²) | | | | | |
| Thermal conductivity | 148 | 1.17 | — | 2.6 [1 0 0] | 16 |
| (W/m-K) | | | | 3.8 [0 1 0] | |
| | | | | 3.4 [0 0 1] | |
| Raman gain | 20 | 11 | 4.8 | 3.3 | — |
| (cm/GW) | (1550 nm) | (1064 nm) | (1064 nm) | (1064 nm) | |
| Transmission Range | 1.1-6.5 | 0.38-1.8 | 0.38-5.5 | 0.35-5.5 | 0.2-5.3 |
| (μm) | | | | | |
| Refractive | 3.42 | 1.556 | 1.84 | 1.986-2.033 | 1.884 |
| index | | | | | |
| Raman shift at | 521 | 1047.3 | 770 | 901 | 910.7 |
| 300 K (cm⁻¹) | | | 822 | 768 | |
| Spontaneous | 3.5 | 0.4 | 5.0 | 5.9 | 4.8 |
| Raman | | | | | |
| linewidth (cm⁻¹) | | | | | |

FIG. 2 depicts an example of a multimode self-imaging Raman waveguide amplifier system 50 that can be implemented according to an aspect of the present invention. The system 50 includes a waveguide 52 that includes a core 54 and an appropriate cladding 56. The cladding 56 has a lower refractive index than the waveguide core 54 to keep the signals propagating in the transverse modes of the multimode core. In the example of FIG. 2, pump power is input into the waveguide 52 from a plurality of incoherent optical sources, indicated schematically 56. The pump sources 56 can be, for example, color center lasers, semiconductor diodes, fiber lasers, or other devices and apparatuses that can generate the pump beams within the desired wavelength spectrum. For instance, each of the sources 56 can be pump beams 62 having a net spectral width that is less than the Raman gain linewidth of the core 54 and are of sufficient beam quality to enable coupling into the waveguide 52. The pump beams from each of the sources 56 are coupled to the waveguide core 54 through an optical network, schematically depicted at 58, to provide the pump beams 60 to an input end 60 of the waveguide 52. Those skilled in the art will appreciate various approaches and optical coupling networks that can be utilized to couple the pump beams 62 to the waveguide 52.

In the example of FIG. 2, an input Stokes beam 64 is provided at another input end 66 of the waveguide 52. The input Stokes beam 64 can be provided by any one or more of a number of optical sources capable of providing a diffraction limited beam having desired beam characteristics. The waveguide 52 performs coherent amplification process via stimulated Raman scattering to provide an amplified output beam 68 that is substantially an amplified replica of the input Stokes beam 64. The waveguide 52 thus can provide a diffraction limited output beam 68 that is an amplified replica of the input Stokes beam 64. For instance, the output Stokes beam 68 can be obtained from the waveguide 52 by dichroic beam splitter, grating prism, or other optical devices configured to produce the output beam 68 at the Stokes wavelength. Those skilled in the art will understand that the amplified output beam 68 can be utilized in a variety of applications. For instance, the amplified output beam 68 can be used as a diffraction limited input to an optical parametric oscillator, such as to provide a high power MWIR beam.

The Raman gain of the waveguide core 54 depends on the intensity of the pump signals 62 in the waveguide, as the energy from the pump beams is transferred to the input Stokes beam via Raman scattering. In the example of FIG. 2, the system 50 is depicted as a counter-propagating pump configuration. It is to be understood and appreciated that a co-propagating pump configuration can also be utilized or a combination of counter-propagating and co-propagating pump beams can also be utilized.

In the example of FIG. 2, the waveguide can be operatively connected to one or more heat sinks 70 to dissipate heat generated during operation of the waveguide amplifier system 50. The waveguide cladding 56 and core 54 can be formed of materials having high thermal conductivity (e.g., see Table 1) to facilitate heat transfer from the waveguide 52 to the heat sink 70.

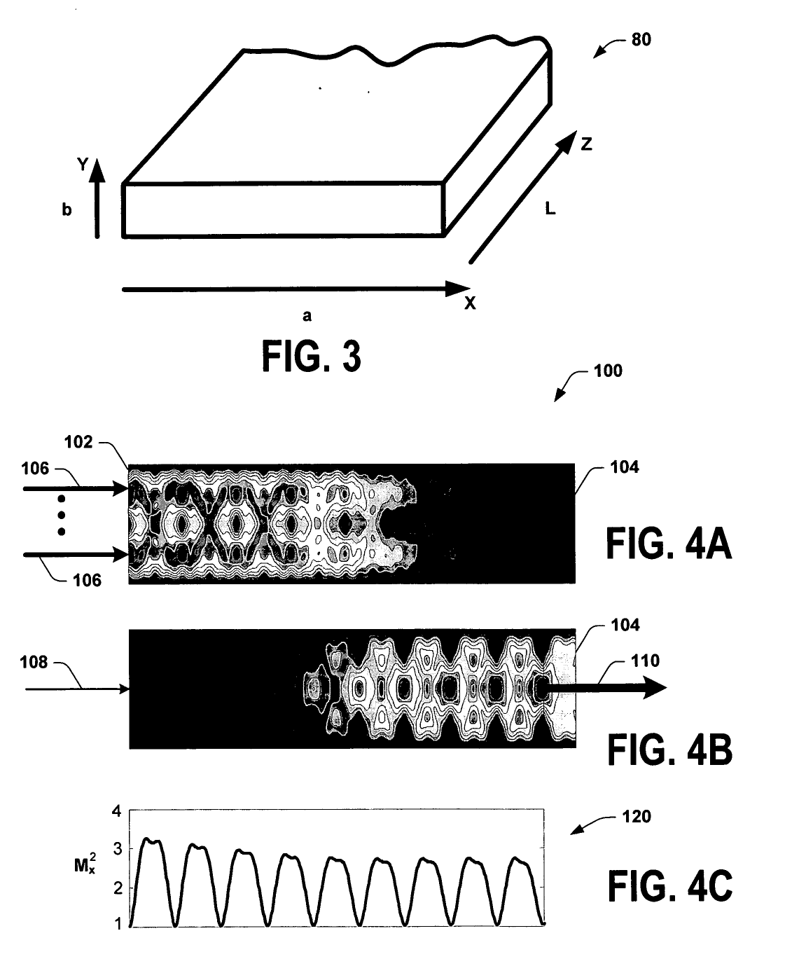

Certain characteristics and properties of a multimode self-imaging Raman waveguide (e.g., as shown and described with respect to FIGS. 1 and 2) will be better appreciated with respect to the following discussion and with reference to FIG. 3. FIG. 3 depicts and example of a multimode waveguide core 80 in three dimensions depicted as X, Y, and Z. The dimension (width) of the waveguide core 80 in the X-direction is denoted as “a,” the dimension (thickness) in the direction of Y is denoted as “b” and the dimension (length) in the direction of Z is denoted by “L.” The thickness (b) of the core FIG. 3 determines the number of modes in the Y direction. The width (a) determines the number modes in the X direction. For the following discussion, it will be assumed that “a” is greater than “b” (a>b) such that there are plural modes in the X direction and only one mode in the Y direction. It is to be understood and appreciated that there can be more than one mode in the Y direction. The waveguide modes can be represented by Greek letter φᵢⱼ as follows:

$${φ}_{ij} = \sqrt{\frac{4 {Z}_{O}}{ab}} Sin ( \frac{i π x}{a} ) Sin ( \frac{j π y}{b} ) , 0 < x < a and 0 < y < b \qquad Eq . 1$$

where i,j=to 1,2,3, . . . n—corresponding to the Eigen function normalized to unit power; and

Z₀=waveguide impedance.

An input mode profile ψᵢₙ can be expressed with a Gaussian mode at the center as follows:

$${ψ}_{in} = \frac{\sqrt{{PZ}_{O}}}{w \sqrt{2 π}} \cdot exp ( \frac{- {( x - a / 2 )}^{2}}{4 {w}^{2}} ) exp ( \frac{- {( y - b / 2 )}^{2}}{4 {w}^{2}} ) \cdot exp ( j θ ) \qquad Eq . 2$$

where the total power is normalized to P,

w represents the Gaussian beam width; and

θ represents an input phase factor for the mode.

The foregoing function of equation 2 can be changed based on the launch condition. As one example, given a waveguide in which a=125 micrometers, b=50 micrometers and the Gaussian width is equal to 40 micrometers

$$( \frac{1}{{e}^{2}} width ) ,$$

considering as few as seven modes along the X-axis and one mode along the Y-axis thereby provides a coupling efficiency of approximately 98%. For such waveguide, the mode coefficients can be expressed as follows:

$$Mode coefficents \text{:} {A}_{ij} ( 0 ) = \frac{1}{{Z}_{O}} {\int }_{0}^{b} {\int }_{0}^{{a}_{*}} {ψ}_{in} \cdot {φ}_{ij}^{*} d x d y \qquad Eq . 3$$

where:

$${ψ}_{in} = ψ ( 0 ) = \sum {\sum }_{modes} {A}_{ij} {φ}_{ij} ; \qquad Eq . 4$$

and

$$ψ ( z ) = \sum {\sum }_{modes} {A}_{ij} {e}^{i {β}_{{ij}^{z}}} {φ}_{ij} \qquad Eq . 5$$

The self-imaging length depends on wavelength, waveguide dimensions and refractive indices of the core and the cladding materials. More particularly, from the foregoing, it can be shown that the self-imaging length (L_{T}) (also referred to as the self-imaging period or repeat length) varies as a function of the width and indices of refraction of the waveguide core and cladding and as a function of the wavelength of the light propagating through the core. For the example of a passive waveguide, the self-imaging length (L_{T}) can be derived as follows:

$${β}_{ij}^{2} = {( {kn}_{0} )}^{2} - {( i \frac{k π}{a} )}^{2} - {( j \frac{k π}{b} )}^{2} \qquad Eq . 6$$

where k=wave number of the waveguide medium;
n₀ is the material refractive index.

$$Imaging length , {L}_{T} = \frac{4 {n}_{0} {a}^{2}}{{λ}_{0}} \qquad Eq . 7$$

A mode analysis that includes the effects of Raman gain (SRS), the effects of self-phase modulation (SPM) and the effects of cross-phase modulation (XPM) for the self-imaging Raman waveguide can be represented according to the following:

$$\begin{matrix}\frac{d {A}_{Smn}}{d z} = {\sum }_{k} {\sum }_{l} {κ}_{mn - kl}^{SRS} {A}_{Smn} {\vert {A}_{Pkl} \vert}^{2} + ( SPM and XPM terms ) & Eq . 8 \\ \frac{d {A}_{Pmn}}{d z} = - \frac{{ω}_{P}}{{ω}_{S}} {\sum }_{k} {\sum }_{l} {κ}_{mn - kl}^{SRS} {A}_{Pmn} {\vert {A}_{Skl} \vert}^{{2}^{*}} + ( SPM and XPM terms ) & Eq . 9\end{matrix}$$

where: the first term

$${\sum }_{k} {\sum }_{l} {κ}_{mn - kl}^{SRS} {A}_{Smn} {\vert {A}_{Pkl} \vert}^{2}$$

in Eq. 8 corresponds to the Raman gain χ⁽³⁾ due to SRS,
and where Kₘₙ₋ₖₗ^{SRS}, can be expressed as follows:

$${κ}_{mn - kl}^{SRS} = {ω}_{S} {E}_{o} {\int }_{0}^{b} {\int }_{0}^{a} {φ}_{Smn} {φ}_{Smn}^{*} ( {χ}_{SRS}^{( 3 )} ) {φ}_{Pkl} {φ}_{Pkl}^{*} d x d y \qquad Eq . 10$$

Thus, assuming a pump wavelength of about 2.94 μm, for example, the Raman process scattering can provide a third order nonlinear electric susceptibility χ⁽³⁾=1.6×10⁻¹⁸ m²/V².

FIGS. 4A, 4B and 4C depict expected simulation results for stimulated Raman amplification in a multimode self-imaging Raman waveguide that can be implemented according to an aspect of the present invention. In FIG. 4A, the depletion of an input pump signal is depicted along the propagation direction Z that extends between a first end 102 and a second end 104 of the waveguide 100. In the example of FIG. 4A, a plurality (e.g., two or more) pump signals 106 are provided at the input 102 for amplifying a corresponding input Stokes beam 108 as shown in FIG. 4B. In FIG. 4B, the amplification of the input Stokes beam 108 is depicted as occurring along the propagation direction between the ends 102 and 104. Thus, from comparison of FIGS. 4A and 4B it is shown that as the pump signals 106 depletes, the corresponding Stokes shifted signal is amplified substantially commensurate with the depletion of the pump signals 102. The self-imaging property of the propagating signals is also illustrated by the periodic reconstitution along the propagation direction. The result is an output signal 110 that is an amplified replica of the input Stokes signal 106 due to stimulated Raman scattering caused by the pump beams 106 in the Raman-active medium.

FIG. 4C depicts a graph illustrating beam quality (M_{X}²) along the propagation direction of the waveguide 100 exhibiting the self-imaging property described above. From the example of FIG. 4C, it is shown that there may be some minor degradation in beam quality of the input Stokes beam as depicted at the position of the self-imaging planes. The output Stokes beam 110, shown in FIG. 4B, thus can provide a desired (nearly) diffraction limited beam with desired beam characteristics suitable for many applications. Additionally, due to the Raman gain amplification process caused by the pump beams and the stimulated Raman scattering, the output beam 110 can be provided at a power level greater than most conventional systems. For example, proper selection of the input Stokes beam 106 and by providing the pump signals 102 within the Raman gain linewidth of the Raman gain medium that forms the waveguide 100, depletion of power from the input pump beams 102 can be utilized to provide a high power MWIR output beam at 110. It will be appreciated that (from Eq. 7), the location of the self-imaging planes can change with wavelength, but the corresponding effect should be tolerable for most practical applications. The minor degradation in beam quality also should be acceptable for such applications.

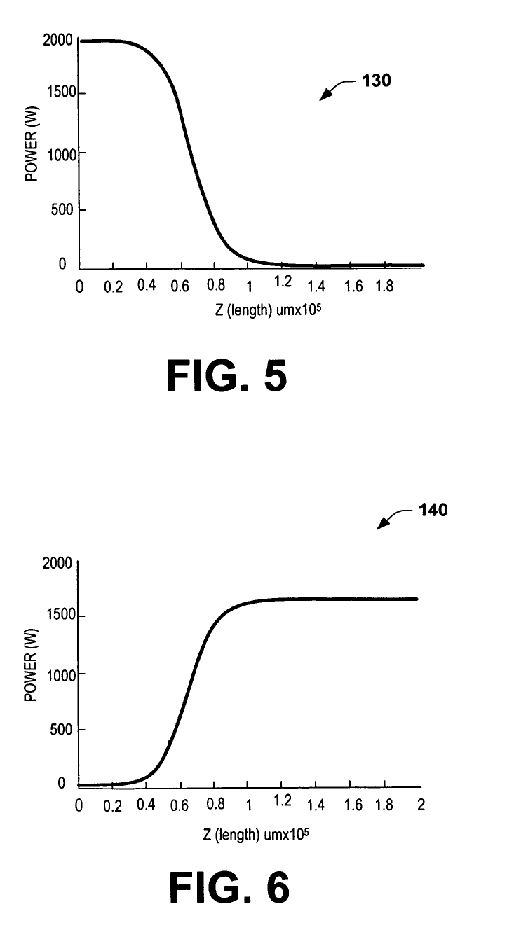

An evolution of power along a length of a self-imaging multimode waveguide implemented according to an aspect of the present invention is shown in FIGS. 5 and 6. In FIG. 5, the graph 130 is shown for the pump power, illustrating depletion of the pump power along the propagation direction Z. In FIG. 6, there is a corresponding increase in power of the Stokes beam also along the Z axis of the waveguide, demonstrating a gain of greater than about 30 dB. Those skilled in the art will understand and appreciate that the gain in the input Stokes beam will vary depending upon the input pump power and the Raman gain characteristics of the Raman gain medium utilized to provide the core for the waveguide structure, as described herein.

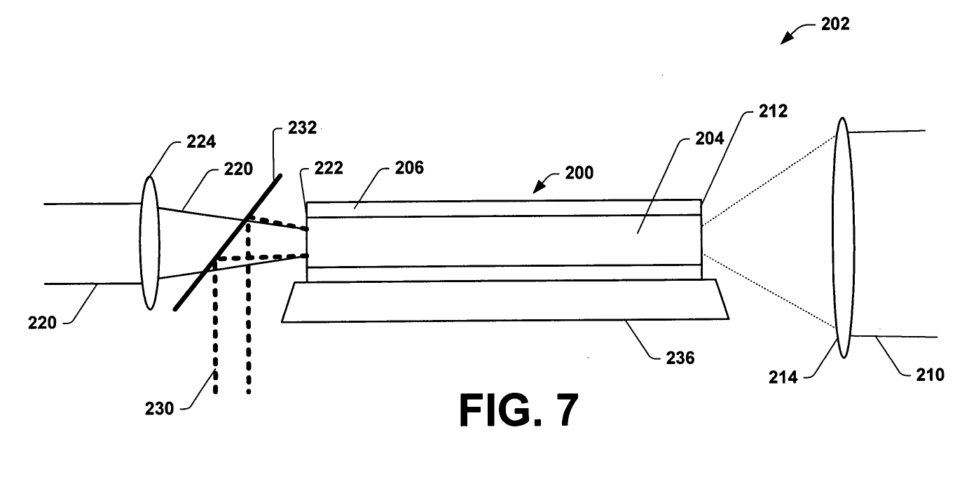

FIG. 7 depicts an example in which a self-imaging Raman multimode waveguide 200 is utilized as part of an image amplification system 202. The waveguide 200 includes a multimode core 204 of a Raman active medium, such as described herein. The core 204 can be arranged in a variety of shapes to provide a planar waveguide and can be surrounded by an appropriate cladding material 206. An input image 210 is coupled to an input end 212 of the waveguide 200 such as through appropriate optics, schematically illustrated at 214. The input image 210 is provided at the desired Stokes wavelength or a spectrum that resides within the Raman gain linewidth for the Raman active medium that is utilized to provide the core 204. The input image 210 can include a distribution of phase, amplitude and frequency from a wide field of view that is provided to the input end 212. It is to be understood and appreciated that since the waveguide is a multimode waveguide it can accept a large field of view, and the various modes can correspond to light from various incident directions relative to the input end 212. The input image 210, for example, can correspond to beams reflected off one or more objects (stationary and/or moving) within the object field of view that, in turn, are focused onto the input end 212 of the waveguide 200 via the optics 214. Thus, the amplified output 230 can correspond to a diffraction limited Stokes image having a distribution of phase, amplitude and frequency corresponding to the input image 210.

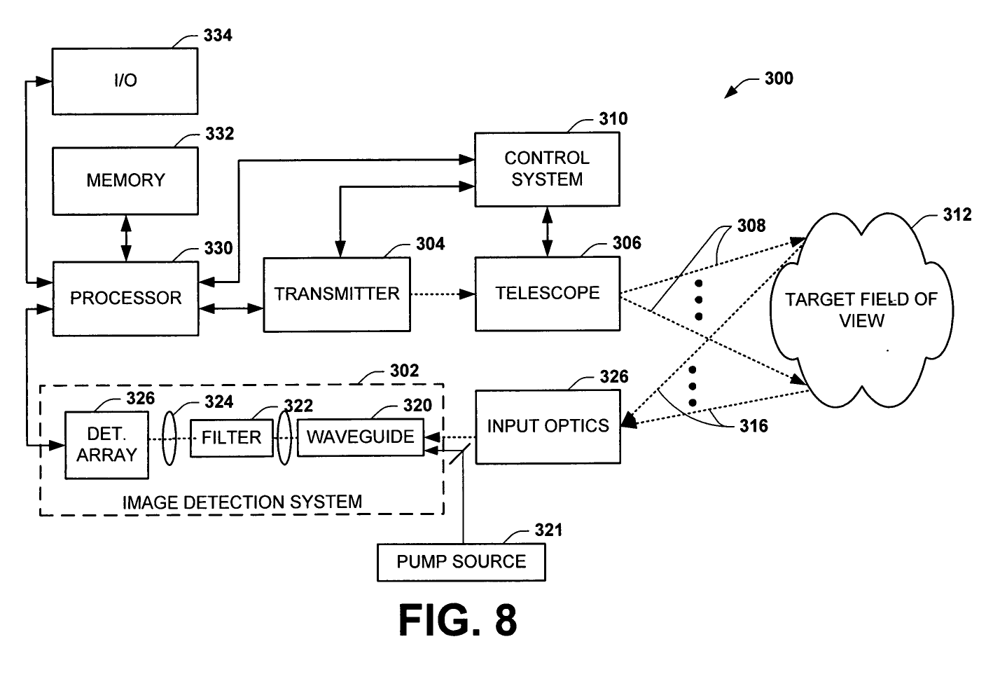

One or more input pump beams 220 is also provided to the waveguide 200 to achieve corresponding Raman gain for amplifying the input image 210. In the example of FIG. 8, the input pump beam 220 is provided as a counter-propagating beam at an input end 222 of the waveguide 200 through corresponding coupling optics, schematically illustrated at 224. It is to be understood that the system 202 could be implemented with a co-propagating or a combination of co-propagating and counter-propagating pump beams. The pump beam 220, which can be incoherent beams, can be a single pump beam or a plurality of pump beams having an aggregate power that is commensurate with or greater than the desired output power for the input image 210. The wavelength of the input pump beam 220 is shorter (e.g., more energetic) than the wavelength of the input image. By providing the pump beam or beams 220 at a proper wavelength the waveguide 202 exhibits transient Raman gain at the Stokes shifted wavelength corresponding to the specific pump wavelength. It is to be understood and appreciated that a desired wavelength or a wavelength spectrum of the input image 210 thus can be amplified to a desired level through Raman scattering by appropriately selecting the input pump beam(s) 220 as to reside within the Raman gain linewidth of the Raman active medium (e.g., crystal material) that is utilized to provide the core 204 of the waveguide 200.

The waveguide 200 can also be configured to have an appropriate length to take advantage of the self-imaging property of the multimode waveguide. In this way the corresponding input image 210 (beam at the Stokes wavelength) can be coherently amplified along the propagation direction of the waveguide 200 to provide the amplified output beam 230 at 220. The output beam 230 thus corresponds to an amplified replica of the corresponding input beam at the Stokes wavelength. Due to beam cleanup that can occur along with the amplification and self-imaging in the waveguide 200, the output beam 230 thus exhibits desired beam and image characteristics consistent with the input image 210 (see, e.g., FIGS. 4A, 4B, and 4C). Appropriate optics, schematically indicated at 232, can be utilized to separate the amplified output beam 230 from the pump beam 220.

While the foregoing discussion has described the system 202 in terms of an input image and image amplification, it is to be understood and appreciated that the input image 210 could correspond to a plurality of discrete diffraction limited beams at the Stokes wavelength, each of which can be amplified through the Raman amplification process to amplify the one or more beams at a desired wavelength or wavelength spectrum. For example, a low level high quality diffraction limited Stokes beam 210 can be provided in the MWIR range and with appropriate pumping power by one or a plurality of pump beams 220 at an appropriate shorter wavelength. The energy from the pump beams 220 can result in Raman amplification of the Stokes beam or beams in a coherent amplification process with self-imaging to provide a high quality amplified replica of the input Stokes beam 210.

FIG. 8 depicts an example of a ladar system 300 that includes an image detection system 302 in accordance with an aspect of the present invention. The ladar system 300 includes a transmitter 304 that is configured to emit laser radiation. For example, the transmitter 304 includes a pulsed or continuous laser system comprising a high power amplifier and oscillator subsystem (as are known in the art and therefore not shown for purposes of brevity). A control system 310 can be operatively connected to control a telescope 306 and/or the transmitter 304 for directing (or pointing) the beam at the desired target scene or target field of view 312. The control system 310, for example, can control the transmitter 304 to produce continuous wave or pulsed laser radiation beam into the field of view. The telescope 306 collimates and projects the beam(s), indicated schematically at 308. The beam(s) 308 can be sufficiently wide to encompass or floodlight a target scene of interest, including any number of one or more objects 310 in the target scene.

As one example, a plurality of different beams 308 can be directed at different elevation angles and over a range of azimuth angles to cover a predetermined two dimensional field of view. For example, each beam 308 can correspond to a pulse of electromagnetic radiation at one or more wavelengths and having a predetermined pulse duration (e.g., in a range of about 3-10 ns). The wavelength of the beam(s) 308 are selected to reside in the Raman gain linewidth (or spectral band) of a self-imaging Raman multimode waveguide 320 implemented in the image detection system 302 according to an aspect of the present invention. As described herein, the Raman gain linewidth can be set by providing one or more pump beams at appropriate wavelength(s) according to the Raman gain spectrum of the Raman active gain medium of the waveguide.

A portion of the transmitted laser beam 308 is reflected as one or more return beams from the one more objects 310 in the field of view back toward the ladar system 300. The objects 310 can be stationary or moving in two- or three-dimensional space. Input optics 314 (e.g., including one or more lenses and a narrow band filter) collects the return beam (or beams), indicated at 316. The same optics can be used for both transmitting and receiving the laser energy, such as if means (e.g., a transmit and receive switch) are available for isolating the outgoing and returning signals. The input optics 314 collects the return beam(s) 316 and relays the received light onto an input facet of the waveguide 320. A pump system 321 provides one or more pumping beams to the waveguide 320 to amplify the received light that travels along the length of the core via Raman gain. The pump beams can be provided relative to the input beam(s) as co-propagating, counter-propagating or a combination thereof.

According to an aspect of the present invention, the waveguide 320 has a core that is dimensioned configured as a multimode and self-imaging Raman amplifier. The waveguide 320, being a multimode configuration, has an aperture to receive light beams over a broad range of incidence angles, which received beams are amplified as they propagate as different modes through the waveguide 320. By configuring the length of the waveguide 320 to correspond to a self-imaging length (as described herein), the different modes of the amplified Stokes signal at the output facet of the Raman amplifier 320 substantially replicate the Stokes signal at the input end of the waveguide.

The waveguide 320 provides the amplified output signals to a suitable filter to remove a substantial portion of the amplified spontaneous emissions and non-image or pump beams. For example, the filter 322 can be configured as a narrow band-pass filter to remove out-of-band amplified spontaneous emissions and other noise. Since the amplified spontaneous emissions are distributed substantially uniformly over a broad range of frequencies, the filtering affords enhanced spatial rejection of spontaneous emissions for the target band or subset of bands (corresponding to the transmitted beams). One or more lenses 324 are arranged to image the filtered amplified light signals onto focal plane detector array 326. The detector array 326 detects the received image and converts it to an appropriate electronic signal format. Each photo-detector element in focal plane detector array 326 converts incident light power into a corresponding electric charge. For example, the focal plane detector array 326 collects data periodically corresponding to different temporal images (or frames) that spatially describe the object or objects 310 within the field of view. The data collected over time can define a two-dimensional representation of the object(s) in the target field of view 312 of the ladar system 300 over any number of frames.

The ladar system 300 also includes a signal processor 330 and associated memory 332. The memory 332 can include read-only memory (ROM), random access memory (RAM), and mass storage memory (e.g., hard disk drives, flash memory) or other types of memory suitable for implementing the ladar system 300. The signal processor 330 can be implemented as one or more microprocessor or digital signal processors programmed and/or configured to control and implement the ladar functions.

For example, the processor 330 can execute instructions (stored in the memory 332) to compute range, distance or velocity for each of a plurality of targets according to radiation energy rays received at corresponding incidence angles relative to the aperture of ladar transmitter 304. The processor 330 further can forms range cells for each of such incidence angles. The range or distance computations can be implemented in a variety of ways, such as by performing the Discrete Fourier Transform (DFT) on the time signal resident in each pixel. Other ranging and distancing functions can be utilized to provide a corresponding transformed data set, such as based on implementing a range counter based on a start and stop clock times for signals transmitted to the target scene of objects 310. The signal processor 330 can employ the transformed data set to form three-dimensional image data of the illuminated target scene 312, including one or more objects 310 located in the scene. The memory 332 can contain the algorithm utilized by the signal processor 330 as well as store the collected and transformed data to provide a corresponding representation of the image to an input/output device 334.

For example, the input/output device 334 can include a display monitor (e.g., CRT or LCD based display system) as well as an associated human-machine interface. The range and distance information associated with the scene further can be supplied directly (or indirectly) to other systems, including for implementing targeting and safety systems. Those skilled in the art will understand various types of display formats and other outputs (e.g., visual or audible) that can be provided based on computations performed by the signal processor 330.

By way of further example, one particular measure of ladar system 300 performance is the signal-to-noise ratio (SNR) at the output of each element (pixel) in the focal plane detector array 326. The SNR produced for given target illumination conditions is proportional to the sensitivity of the detector. The optical amplification of the image can also improve the sensitivity of the imaging receiver 302, such as to achieve significant system gains. For example, the approach described herein also provides a potential improvement in imaging ladar receiver sensitivity of 15-30 dB or greater, which translates directly to a potential reduction of the same order for the required transmitter power. Thus, by implementing using a self-imaging multimode Raman waveguide amplifier 320, according to an aspect of the present invention, detectors of reduced sensitivity (e.g., less expensive detectors) can be utilized in the array 326 without reducing performance relative to many existing ladar systems. Alternatively, an increase in receiver 302 sensitivity can enable a reduction in transmitter power while maintaining a constant SNR. Moreover, the self-imaging property and Raman amplification can also enable a the detector array to be implemented with smaller detector elements relative to many existing ladar systems, such that the ladar system 300 as a whole can to be made smaller.

There are many ladar applications in which it is desirable to illuminate a large target volume and detect the return signals from multiple targets within that volume simultaneously. An example would be a space interceptor seeking inbound warheads. Another would be imaging through foliage or camouflage netting. The approach described herein thus enables these and other applications to be realized along with a corresponding reduction of transmitter power required or an increased probability of detection. For example, the image detection systems, as shown and described herein, can also be utilized in other types of systems, such as including but not limited to wavefront sensors or lasercom multiple access receivers.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A Raman waveguide amplifier comprising:
a waveguide comprising a core of a Raman-active medium dimensioned and configured as a self-imaging multimode waveguide;
at least one input signal coupled into the core at a wavelength within a Raman gain spectrum of the Raman-active medium relative to at least one pump beam; and
the at least one pump beam being coupled into the core so as to amplify the at least one input signal via stimulated Raman scattering to provide an output signal corresponding to an amplified replica of the at least one input signal.

2. The amplifier of claim 1, wherein the wavelength of the at least one pump beam exceeds the wavelength of the at least one input signal by a predetermined amount selected according to Raman gain characteristics of the Raman active medium.

3. The amplifier of claim 1, further comprising an optical pump source configured to provide the at least one pump beam as comprising at least one incoherent pump beam.

4. The amplifier of claim 3, wherein the at least one incoherent pump beam further comprises a plurality of incoherent pump beams having a net spectral width that approximates or is less than the Raman gain linewidth.

5. The amplifier of claim 1, wherein the Raman-active medium has properties of being transparent at the wavelength of the at least one pump beam and at a downshifted Stokes wavelength corresponding to the at least one input signal.

6. The amplifier of claim 1, wherein the Raman-active medium comprises a crystal material.

7. The amplifier of claim 6, wherein the crystal material is selected from a group consisting essentially of: silicon (Si), diamond (C), silicon carbide (SiC), barium nitrate (Ba(NO₃)₂), lithium iodate (LiIO₃), potassium gadolinium tungstate (KGd(WO₄)₂), calcium tungstate (CaWO₄).

8. The amplifier of claim 1, wherein the at least one input signal comprises a diffraction limited beam at a desired Stokes wavelength such that the output signal comprises a corresponding diffraction limited output signal.

9. The amplifier of claim 8, wherein the desired Stokes wavelength resides in the mid infrared region.

10. The amplifier of claim 1, wherein the at least one input signal comprises an input image corresponding to a field of view that comprises image light within the Raman gain linewidth, such that the image light within the Raman within the Raman gain linewidth is amplified in the core by stimulated Raman scattering resulting from the propagation of the at least one pump signal through the core to provide the output signal as an amplified replica of the input image.

11. The amplifier of claim 1, wherein the core has a length between spaced apart ends that is dimensioned to provide for periodic replication of an optical electrical field distribution at a given plane transverse to the axis of the core and in the direction of propagation at points that are multiples of a self-imaging period of the waveguide.

12. The amplifier of claim 1, wherein the each of a plurality of Stokes modes of the input signal are amplified by plural pump modes without regard to relative phase of the at least one input signal and the at least one pump beam.

13. The amplifier of claim 1, further comprising a heat sink attached to the waveguide to dissipate heat generated in response to the stimulated Raman scattering that occurs in the waveguide.

14. A Raman multimode amplifier system comprising:
means for propagating multiple optical modes along a direction of propagation and for periodically replicating an optical electrical field distribution at a given plane transverse to a longitudinal axis thereof in the direction of propagation at points that are multiples of a self-imaging period; and
means for pumping at least one pump beam to provide for stimulated Raman scattering in the means for propagating, such that at least one Stokes signal coupled to a first end of the means for propagating is amplified by the stimulated Raman scattering to provide a corresponding output signal at a second end thereof that is an amplified replica of the at least one Stokes signal.

15. The system of claim 14, wherein the means for pumping further comprises means for providing a plurality of incoherent pump beams to at least one of the first and second ends of the means for propagating, the plurality of incoherent beams having a net spectral width that approximates or is less than the Raman gain linewidth.

16. The amplifier of claim 1, wherein the means for propagating has properties of being transparent at the wavelength of the at least one pump beam and at the wavelength of the Stokes signal.

17. The system of claim 16, wherein the at least one input signal comprises a diffraction limited beam at a desired Stokes wavelength such that the output signal comprises a corresponding diffraction limited output signal.

18. The system of claim 14, wherein the each of a plurality of Stokes modes of the Stokes signal are amplified by plural pump modes without regard to relative phase of the Stokes signal and the at least one pump beam.

19. The system of claim 1, further comprising means for dissipating from the means for propagating that occurs due to the stimulated Raman Scattering.

20. A method for amplifying a diffraction limited input optical signal, comprising:
providing a waveguide core of a Raman active medium, the core being dimensioned and configured to propagate multiple optical modes along a direction of propagation and for periodically replicating an optical electrical field distribution at a given plane transverse to the direction of propagation at points that are multiples of a self-imaging period; and
pumping the waveguide core with at least one pump beam within a Raman gain linewidth for the Raman active medium as to amplify the input signal through stimulated Raman scattering and thereby provide an amplified diffraction limited output signal at an output of the waveguide core.
